(19) United States
(12) Patent Application Publication
(10) Pub. No.: US 2016/0243546 A1
(43) Pub. Date: Aug. 25, 2016

(54) MELT-AND-MOLD FABRICATION (MnM FAB) OF RECONFIGURABLE DEVICES

(71) Applicant: MASSACHUSETTS, UNIVERSITY OF, Boston, MA (US)

(72) Inventors: Martin Thuo, Ames, IA (US); Ian Tevis, Brighton, MA (US); Zhi Li, Braintree, MA (US)

(21) Appl. No.: 15/047,340

(22) Filed: Feb. 18, 2016

Related U.S. Application Data
(60) Provisional application No. 62/118,170, filed on Feb. 19, 2015.

(51) Int. Cl. B01L 3/00

(52) U.S. Cl. CPC B01L 3/502707; B01L 2300/126; B01L 2200/12

(57) ABSTRACT

A low-melting material, such as Field's metal or related alloy, may be molded into a device which can then be reconfigured to fabricate another device. Related methods and kits are also disclosed for various humanitarian, military, and industrial applications.

### CROSS-REFERENCE TO RELATED APPLICATION

This application claims the benefit of priority under 35 U.S.C. §119(e) to U.S. Provisional Patent Application Ser. No. 62/118,170, filed on Feb. 19, 2015, titled “Melt-and-Mold Fabrication (MnM Fab) of Reconfigurable Low-Cost Devices for Use in Resource-Limited Settings,” the entire disclosure of which is hereby incorporated herein by reference in its entirety for all purposes.

### FIELD OF THE TECHNOLOGY

One or more aspects relate to the fabrication of reconfigurable devices and, more specifically, to melt-and-mold fabrication (MnM Fab) of reconfigurable devices.

### BACKGROUND

A major challenge in healthcare, and in food and clean water supply, is the lack of locally-available tools to diagnose diseases, measure nutrient content, detect food toxins, or assess the quality of water. The lack of readily available, quality, and reliable diagnostic tools, and the lack of necessary infrastructure, for example, roads and bridges to facilitate uninterrupted supply, in the resource-limited developing world makes these tasks even more challenging and expensive. The availability of cellular communication, however, has allowed for a global influx of information, some of which is free. It is therefore feasible that new approaches to diagnosis and analytical measurements can take advantage of the growing global connectivity and transfer device fabrication capability to those who need it most. This model has worked well in agricultural practices, where the need for food for a growing population has allowed integration of better farming practices, for example, strip farming, contour farming, and gabion construction, in many parts of rural Africa. Similarly, adoption of formal educational and industrialization principles has taken off in most parts of the world, not only through material transfer, but predominantly through information sharing and local customization.

### SUMMARY

In accordance with one or more aspects, a method of fabricating a device may comprise molding a material to form a first device, and reconfiguring the first device to form a second device. The material may comprise a low melting point material. In at least some aspects, the material may comprise Field's metal. At least one of the first and second devices may be a diagnostic device. At least one of the first and second devices may be a microfluidic device, an optical grating, or a well plate. In some aspects, reconfiguring the first device may involve a melt-and-mold (MnM) fabrication technique. In at least some aspects, the method may further comprise using one of the first and second devices to run a diagnostic test. The method may still further comprise reporting data collected from the diagnostic test.

In accordance with one or more aspects, a diagnostic kit may comprise a source of a reconfigurable material, at least one mold, and instructions for using the reconfigurable material and the at least one mold to form at least one reconfigurable device. The instructions may relate to a melt-and-mold (MnM) fabrication technique. In some aspects, the reconfigurable material may comprise Field's metal. The at least one mold may be made of plastic, rubber, metal, paper, wax, wood, stone, or glass. In at least some aspects, the at least one reconfigurable device is a diagnostic device. The at least one reconfigurable device may be a microfluidic device, an optical grating, or a well plate. The kit may further comprise a wearable device configured to hold the components of the kit. The kit may comprise a crucible configured to facilitate processing of the reconfigurable material and/or a source of heat to facilitate processing of the reconfigurable material. In some non-limiting aspects, the kit may further comprise a diagnostic test reagent. The kit may also include instructions for using the at least one reconfigurable device to perform a diagnostic test. The diagnostic test instructions may comprise a step of communicating data collected from the diagnostic test.

### BRIEF DESCRIPTION OF THE DRAWINGS

The accompanying drawings are not intended to be drawn to scale. For purposes of clarity, not every component may be labeled. In the drawings:

FIGS. 1-7 relate to embodiments discussed in the accompanying Example.

### DETAILED DESCRIPTION

The current approach to low-cost diagnostic devices is heavily dependent on low-cost, widely available materials, coupled with simple or affordable processes. Introducing reconfigurable materials and simple affordable processes in accordance with one or more of the presently disclosed embodiments may lead to significantly more affordable devices. In some embodiments, the ability to reconfigure the same material beneficially reduces the amount of materials needed when, for example, scientists are stationed in remote research sites. In at least some embodiments, a single source of moldable material may be reconfigured a plurality of times while beneficially retaining the strength and other properties of the material.

In accordance with one or more embodiments, a material may be used to fabricate a variety of devices. The devices may generally be reconfigurable via melt-and-mold fabrication (MnM Fab) techniques as disclosed herein. In some non-limiting embodiments, a non-profit organization operating in a developing world may supply material and instructions for the production of reconfigurable devices therefrom. In other non-limiting embodiments, the disclosed materials and methods may be used for industrial or military applications. For example, a soldier deployed in a hostile region or for humanitarian efforts may not have sufficient access to fresh supplies and having a small supply of metal that could be reformed into many objects could lessen the overall weight burden and make them effective for longer periods of time. In some non-limiting embodiments, a soldier or aid worker may have a flexible wrist strap containing molds wrapped around their arm that they could unravel, or a booklet with molds.

Various devices, such as diagnostics, may be fabricated and reconfigured therebetween. These include well-plates, microfluidics, or any other simple platform that can be adapted to many bio-applications. Microfluidics can be used to enable point of care diagnostics and early detection of infectious diseases in remote settings. Other diagnostics may quantify glucose in blood, lead in water, sodium in urine, and a malarial antigen in buffer. These are simple tests usually identifying only one component using the biological fluid directly and are rapid. With the appropriate molds, sterile and sealable vials or small beakers could be made. Pipette tips used for dispensing small precise quantities of liquids could also be made.

In accordance with various embodiments, one or more molds may be provided or made to facilitate reconfigurable device fabrication. A molding material may also be provided in sufficient quantity so as to enable the reconfigurable fabrication of various devices therefrom. In some embodiments, the material is a metal such as Field's metal. The material must reversibly melt and freeze with low loss of mass. For example, some waxes that are used for molding can evaporate slowly when molten that will slowly decrease the mass over repeated cycles. Metals such as Field's metal have very low if any vapor pressure. The melting point of the material should generally be low enough to be accessible with a simple fire. This may exclude metals like steel. The material should also have a melting point above at least body temperature or it will melt when handled. It should also be tolerable is most application environments Likewise, the materials must withstand treatment with boiling water. Boiling tools in water is a common practice for sterilizing. The boiling of the metal can be used to melt/recover the metal and sterilize it at the same time or it could be used to sterilize metals depending on the melting point. Other low melting metals in addition to Field's metal are envisioned. Some, for example, may contain lead or cadmium.

Various materials including plastic, rubber, metal, paper, waxes, wood, stone, and glass can be used for the molds themselves. The molds should be made of materials that do not degrade or deform appreciably during molding. Most waxes would not work for some high melting metals as they could melt, but polyethylene waxes may be used for a Field's metal molding material. Paper should not be used with metals that melt above its flash point temperature. Aluminum foil has a high melting point and a thin oxide coating that prevents metals from sticking to it and can be used with most metals. Many plastic molds can soften at high temperatures and must be selected to accommodate the temperature of the metal being molded. The mold must be able to be removed physically or through chemical methods like dissolving in a solvent. If a rough or smooth device surface is necessary for an application, then a mold material that can be polished or scuffed can be used. The ability to reuse the molds may be desirable. The shape of the mold should generally correlate with a desired device.

In accordance with one or more embodiments, an MnM Fab kit for the reconfigurable manufacture of various devices may be provided. The kit may include one or more molds associated with desired devices, a supply of molding material such as metal, a crucible for use in material preparation, a source of heat for melting, test reagents and/or instructions. The instructions may be directed to one or more of how to make molds, how to make devices, and various diagnostic test protocols. The kits may generally be compact and/or mobile in accordance with some embodiments.

In at least some embodiments, practitioners, patients, or providers may be an active technology participant involved in device fabrication, running and interpreting the assay, and reporting the data with the help of online protocols available over the cellular bandwidth. To achieve this goal, the requisite diagnostic and/or bio-analytical device(s) should either; i) be derived from locally available materials (abundant and reliable local supply), ii) use cheap (with respect to the immediate socio-economic setting) materials, iii) be easy to fabricate and use, iv) be powered using locally available resources, or, v) be from an affordable reconfigurable material that can be reprocessed and adopted to the myriads of challenges in the field, without the need for sophisticated technology or grid-based power.

Recent developments in low-cost diagnostic and bio-analytical devices are driven, in part, by availability of affordable materials, coupled with low-cost fabrication techniques. This has led to the emergence of, for example, paper-based microfluidic devices, including μ-pads. The availability of affordable wax-printing, 3D printing, and similar technologies has enhanced the quality and complexity of possible paper-based devices. Although these manufacturing and materials processing technologies are available and affordable in the developed world, they are almost non-existent in remote villages and other resource-limited environments. Even if the technology was more widely available, the inherent hydrophilicity of paper would need to be overcome and/or selectively exploited in order to control aqueous bio-fluid movement. This may require additional processing and/or resources to achieve the desired function.

Typical paper device fabrication technologies may provide quality devices, but are often not adaptable for use in regions without power or where the requisite processing technology is unavailable. A more practical development may rely on methods that do not necessarily require grid-based electricity, are simple, and/or can be accomplished with locally available resources. Such stringent requirements would, therefore, require a simple, reliable, and, easy to understand technique like replica molding, described in more detail below, using reusable materials. Only heat and other simple sources of energy, or globally available reagents, are needed. Although the use of a low-cost, abundant material like paper may be desirable in certain regions and applications, other approaches may be needed to introduce new materials in the development of low-cost bio-analytical devices and related technologies.

The current approach to low-cost diagnostic devices is heavily dependent on low-cost, widely available materials coupled with simple or affordable processes. While interest in low-cost analytical devices, particularly diagnostic devices, has recently increased, concomitant field applications have been slow, primarily due to challenges in translation in resource-limited settings. To promote application of these, and related, devices in resource-limited settings, a method that takes advantage of locally available materials, resources, and skills is desired. Introducing reconfigurable materials and simple affordable processes in accordance with one or more of the presently disclosed embodiments may lead to significantly more affordable devices.

In some embodiments, affordable and widely available mold materials may be used to fabricate a variety of devices from a reusable material. Instead of using an inexpensive device material that can be used only once, a more expensive, versatile material that can be remolded many times and for very different applications may be used. Reconfigurable low-cost devices may be produced by a Melt-and-Mold fabrication (MnM Fab) method which can, potentially, be adopted to locally available resources.

Replica molding is a well-established technique for developing devices and tools from soft materials like plastics, metals, and alloys. Molding is simple, versatile, and easy to understand. Molds can be 3D printed, or acquired from other readily available sources as long as they do not wet the materials being molded (high surface energy of most metals enables molds to be sourced from almost any organic material). Molds of multi-well plates, for example, may be derived from acrylonitrile-butadiene-styrene copolymer (ABS) patterned by 3D printing. 3D printed molds may be representative of moldable thermoplastics, which have become almost ubiquitous due to their use as packaging materials. In addition, the diversity of printable structures and availability of thermoplastics inks such as ABS, polyactic acid (PLA), and high impact polystyrene (HIPS).

Reconfigurable materials may be used to create optical gratings. Optical gratings are essential components in spectroscopy. The ability to separate white light into individual wavelengths, or into narrow bands, allows for quality spectroscopic signals and targeted measurements of specific molecular features. Since metals are reflective, it is believed that by replica molding, a standard grating can be used as a mold-template to produce similar features on a metal, which can then be repurposed into other devices after spectral diffraction. The size of the gratings and limitations to flow due to capillary forces may be limiting factors of their fabrication. For example, most gratings have line spacing in the hundreds of nanometers. Conformal flow of molten metals, especially non-Newtonian fluids, into molds with hundreds of nanometers separation can be limited by capillary forces, but it is believed that the melt would sufficiently flow into these channels, giving a satisfactory light diffraction.

MnM techniques may also be used to create devices that can move and manipulate fluid on the micro- and nano-scale, and that have many uses in, for example, particle synthesis, enzymatic analysis, proteomics, and diagnostics. The most commonly utilized material for microfluidic devices is polydimethylsiloxane (PDMS), a siloxane-based elastomer. PDMS can be poured and gently cured at moderate temperatures to provide a transparent and flexible device. PDMS is permeable to many solvents, swells when exposed to certain chemicals, can selectively absorb components out of a solution, and can delaminate. PDMS is a thermoset plastic that cannot be molded or reformed after it has been cured. Typically, a mold for PDMS microfluidic devices is created on a silicon wafer using photolithography, a process that is expensive and has prohibitory high capital costs. Creating a new paradigm using readily available mold materials and reusable device materials may have a major impact in resource-limited countries.

The MnM technique may also be more environmentally friendly than existing practices. Reconfigurable devices fabricated using a MnM Fab technique fulfill at least 9 of 12 principles of green engineering. The reported approach to device fabrication qualifies as green engineering because: i) it uses simple processes that are inherently safe procedures; ii) it applies inherent materials properties (e.g., tensile strength, surface energy, reflectivity, and low Tm) in diverse applications; iii) the fabrication process is simple, and it is easy to design and re-use the total mass of the material, iv) there is low energy input from one device to the other; and v) the materials are recyclable over extended periods of time. This means that reconfigurable devices are both green, affordable, and would lower the cost of such devices, in the long run, while being environmentally benign.

The use of MnM fabrication techniques may lead to a new form of telemedicine. In this telemedicine process, the patient may actively participate in device fabrication, the running and interpretation of the assay, and reporting of the data with the help of online protocols available over the cellular bandwidth. To achieve this goal, the requisite diagnostic and/or bio-analytical device(s) may either: i) be derived from abundant, reliable locally available materials; ii) use inexpensive materials; iii) be easy to fabricate and use; iv) be powered using locally available resources, or; v) be from an affordable reconfigurable material that can be reprocessed and adopted to the myriad of challenges in the field, without the need for sophisticated technology or grid-based power.

Smart analytical platforms or devices may be derived from soft, low-melting point alloys, as examples of reconfigurable, easy to process and re-use materials. Low melting point (Tₘ) metals allow for fabrication of various devices from the same piece of material using well established processes and locally available resources. In fact, appropriate choice of the metal or alloy would mitigate the need for large quantities of materials to make various devices via a MnM Fab process. In microfluidic devices, for example, the low surface energy of the metal means that the devices may be used with both polar and non-polar solutions without affecting the fluid-flow behavior of the channel.

The function and advantages of these and other embodiments will be more fully understood from the following non-limiting example. The example is intended to be illustrative in nature and is not to be considered as limiting the scope of the embodiments discussed herein.

### EXAMPLE

To demonstrate the effectiveness of devices fabricated by the MnM Fab method, three different entry level bio-analytical devices, including a well-plate, an optical grating, and a microfluidic device were fabricated using a low-melting point (<100° C.) metal. The performance of these devices is predictable based on the surface properties of the metal and as such can be customized to fit the need.

First, 4×4 well plates with an inner diameter of 7 mm were created by replica molding of Field's metal comprising 32.5% bismuth, 51% indium, 16.5% tin, and having a melting point of 62° C., on a polymer mold. Next, the well plates were reconfigured into nano-channels in the form of optical gratings, again using the MnM Fab method. The replica gratings, having a 8.0±1.0 nm step height and a 40±1 nm line spacing, compared well to the original mold having a 85.7±6.6 nm step height and 53±2 nm line spacing. The intensity of diffracted light was, however, lower for the MnM Fab grating. It is believed that the lower intensity is primarily due to surface oxidation, phase segregation and reduced channel heights (step height). Finally, the gratings were reconfigured into microfluidic devices demonstrating laminar flow, droplet generation, and bubble formation from T-shaped channels. The molds used in the different devices were produced from known materials like plastic (Acrylonitrile-Butadiene-Styrene (ABS)), glass, and paper. It was found that the MnM method is capable of addressing challenges with device translation and can be extrapolated to other devices as needed in the field.

Fabrication of Molded Well Plates from Plastic Molds

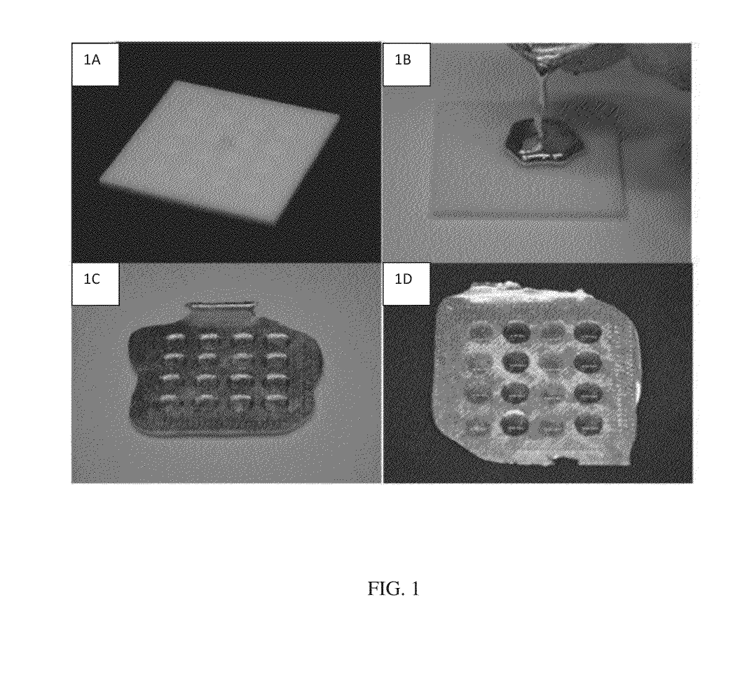

Molded well plates were fabricated from plastic molds. First, models of the desired well plate molds were created using SketchUp® software. 16-well molds were printed using a MakerBot® Replicator 2× 3D printer using an acrylonitrile-butadiene-styrene copolymer (ABS) filament. FIG. 1A illustrates an example of a 16-well mold printed using this process. Molten Field's metal was then poured directly onto the 3D-printed mold, as shown in FIG. 1B, and left to cool at ambient conditions for at least 10 min. The cooled metal easily separated from the plastic molds to provide well-plates with an inner diameter of 7 mm, as shown in FIG. 1C. The well-plates were tested by filling them with different polar and non-polar liquids of various volumes, as shown in FIG. 1D.

The replication has such high resolution that mold defects generated during the 3D printing of the molds are visible in the surface of the metal (such as in FIGS. 1C and 1D). These grooves can be removed from the starting ABS plastic mold either by mechanical grinding or by solvent smoothening using acetone. Post-replication grinding/polishing of the metal well-plates can also be done to shape the device or remove defects inherited from the mold. In some embodiments, the wells can be of different sizes and shapes allowing one to potentially perform multiple experiments with different volume requirements on the same plate and/or reconfigure some of the wells, through hot-embossing, without interfering with other parts of the well-plate. Since these metals readily oxidize in air to mostly generate a passivating oxide layer, the surface of the wells can be chemically modified to generate wells with varying surface properties on the same plate by exploiting the surface chemistry of the native oxide. For example, FIG. 1D shows a 16-well plate with the wells filled with red and blue dyed water. A syringe pump system (Fusion 200, Chemyx Inc.) was used to deliver hexadecane (Alfa Aesar, 99%) dyed with Sudan Red 7B (Amresco), and deionized water containing blue food coloring (McCormick) with 5% Tween 20 (Amresco) to generate droplets or the water was replaced with an air inlet to create bubbles. The rate of fluid delivery varied and was controlled using the accompanying pump software. Device operation was documented with a Nikon D7100 camera. Unlike conventional plastic-based well plates, the reported well plates can accommodate solutions irrespective of the polarity of the solvent with the exception of reactive species like strong acids. One disadvantage of metal-based well plates is the potential for the metal to corrode, especially under acidic conditions, and for alloys, de-alloying can occur depending on the surface composition. This reactivity can be mitigated through surface modification of the well plates, for example, by exploiting the native oxide.

Fabrication of Gratings from Elastomeric Molds

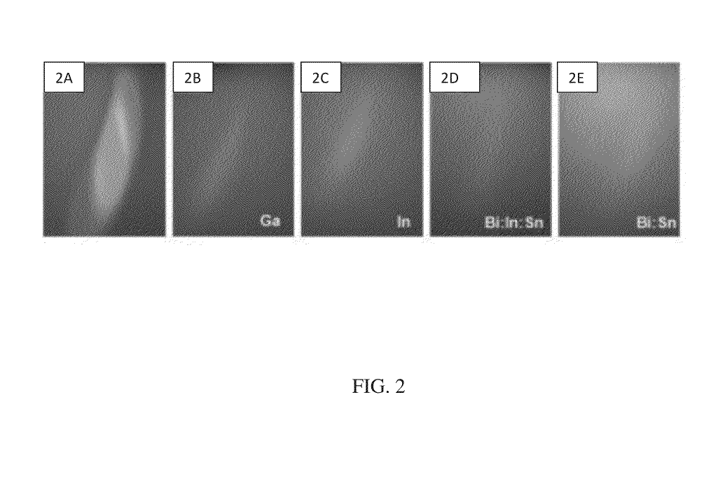

A commercially available reflective diffraction gratings with 1800 grooves/mm and 2400 grooves/mm were purchased from Edmund Optics and used as supplied. High quality commercially available gratings work well for many high end applications but not every application requires high level of resolution—especially where preliminary results are needed to inform decisions for referral to detailed analysis. For low resolution applications, metal replicas may be sufficient for granting fabrications which can be achieved in a two-step MnM fab procedure. To fabricate gratings from reconfigurable devices, the previously fabricated well-plates were targeted as a source of material. To generate the mold, the commercially available grating was covered in liquid PDMS in a 1:10 ratio of curing agent to elastomer, and then cured. The grating was released from the PDMS negative mold leaving a grating sized gap in the PDMS with the negative diffraction grating pattern on the bottom. Molten liquids of gallium, indium, Field's metal (which was previously used to fabricate well-plates), and Bi:Sn were each poured into a mold, cooled, and then released to give replica diffraction gratings. A white light was then used to illuminate the replicated surface and the diffraction pattern was projected onto a white surface and photographed (FIG. 2).

Bruker Innova series AFM was used with a RTESPA probe in tapping mode to characterize the surface features of the gratings. Tapping mode was chosen to avoid disruption of molded surface features, thus preserving the native structure. Images obtained ranged from 3 to 20 μm in width and length using the highest resolution available (1024 samples/line, scanning at 1 Hz). All samples were scanned immediately after preparation to reduce the accumulation of adventitious surface contaminants. Each sample was scanned on the outermost and innermost regions to generate the most accurate representation of the entire surface.

A Zeiss Supra55VP Field Emission SEM was used to examine the micro- and nanostructure of the replica Field's metal gratings to determine the elemental composition of the surface. Samples were imaged using an electron beam accelerating voltage of 15 kV and a working distance of 8.6 mm. Images were collected using an Everhart-Thornley secondary electron detector. Elemental analysis was performed at a working distance of 8.6 mm and using electron beam accelerating voltages of 15 kV. Elemental composition at various accelerating voltages was determined using an Energy Dispersive X-ray Spectrometer with a silicon drift detector.

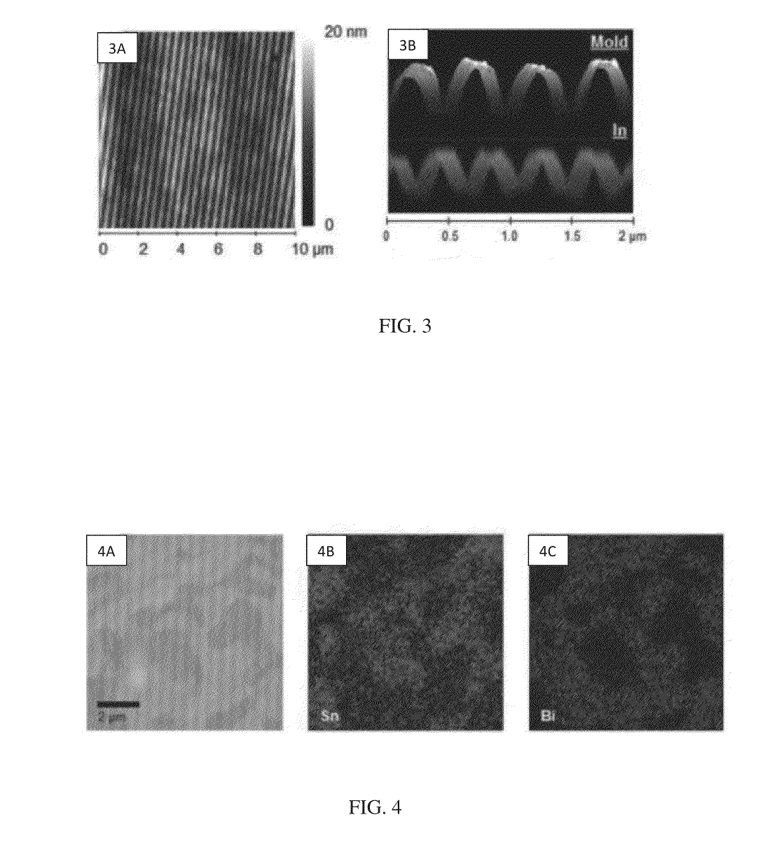

Diffraction of white light by the original aluminum diffraction grating was strong, with clear and intense colors. Diffraction with the metal replicas was clearly visible although it was detected to be relatively weaker in intensity and colors were not as clearly resolved as with the original aluminum grating. The pure metals showed the most intense and defined diffraction patterns compared to the metal alloys. The higher melting indium grating was selected for AFM topography analysis, as shown in FIGS. 3A and 3B. The replica gratings had an 8.0±1.0 nm step height with a 40±1 nm line spacing compared to the original mold which had 85.7±6.6 nm step height and 53±2 nm line spacing. The regular spacing of the replica grating is clear and matches those of the starting grating in line spacing dimensions even after considering the thermal contraction of the indium metal over ˜150° C. The major discrepancy in the replication is in the trough depth where the replicas are much shallower (i.e., low peak-to-valley dimensions) than the commercially available template. Since the liquid metals do not readily wet the PDMS, it was anticipated that capillary forces would limit penetrate of the liquid metal into the line spacing of the PDMS mold.

Thermal contraction of the metal may also reduce the step height, making these surfaces not as diffracting as the commercial more expensive. De-alloying and phase separation can also occur as the liquid metal alloys cool and solidify. Visual inspection of the alloy replicas confirmed that they were not as smooth as the pure metal replicas. The scattered light, during the diffraction experiment, was also not as intense as with the pure metals, as shown in FIGS. 2D and 2F. This increase in surface roughness is most likely due to the separation of metal phase from the alloy melt during solidification of the grating—the metals have different thermal expansivities and change in volume on cooling. Without being bound by theory, it is believed that with surface phase-segregation, the diffraction patterns will be non-uniform as the pure elements have different light reflectivity. SEM imaging of the Field's metal diffraction grating showed surface patchiness such that the surfaces were either highly polycrystalline and/or composed of different elements. Typical Field's metal surfaces are rough because of phase separation. Surface composition was confirmed using energy dispersive X-ray spectroscopy (EDS) elemental mapping, which showed clear phase separation of Sn and Bi corresponding to the different contrast patches seen in the SEM micrograph images of FIGS. 4A to 4C.

It has therefore been concluded that metal alloys that melt at relatively low temperatures can be used to fabricate low-resolution diffraction gratings. They, however, give lower quality diffraction than using pure metals, primarily due to poor reproducibility of surface features inherent in the MmM fab process. Indium, however, melts at 157° C., which may not be compatible with many organic-based mold materials. Gallium had the most intense and clear diffraction pattern. Gallium also readily melts below 30° C., which makes it challenging to use in fairly warm climates. This low Tₘ, however, is convenient for device fabrication but it is a challenge in operation, handling, and analysis.

Fabrication of Microfluidic Devices from Paper Molds

Cardstock paper molds of the desired microfluidic device were created using a craft cutter and accompanying software. Similar molds were also made using ordinary scissors. The paper molds were then glued to a glass support. Hollow metal inlets were then attached, and molten Field's metal was poured over the molds (with the positioned inlets). The device was allowed to cool at ambient conditions for 10 min. The paper was removed from the metal, and the device was placed in an aqueous 1 M H₂SO₄ solution of approximately 95-98% sulfuric acid, for about 30 min to remove any adventitious organics from the paper. Polyethylene tubing was connected to the hollow metal inlets and to the fluid delivery system. The device was sealed with a 1″×3″ microscope glass slide that had been treated with 1H,1H,2H,2H-perfluorooctyltriclorosilane vapor. The device was held together by binder clips.

Paper molds were precisely cut using a Silhouette Cameo craft cutter and then glued to a large glass sheet (FIG. 3A). Various mold designs including; ‘T’, ‘U’, ‘+’, ‘Y’, ‘1’ shapes were made (from 0.2-1.2 mm wide and 0.2-0.6 mm high). Molten recycled Field's metal (used to make well-plates then optical gratings) was poured directly onto the paper molds, cooled and then released from the molds. The glass sheet provided a smooth and flat surface so that the end metal device could be sealed. Occasionally some paper fibers from the mold would get stuck in the narrow channels of the device but could be easily removed with a pair of tweezers. The paper molds are cheap and fast to make so sacrificial molds can be made. Steel needles were used as inlet connectors and a fluoroalkylsilane treated glass slide was used to cover and seal the device with the addition of binder clips.

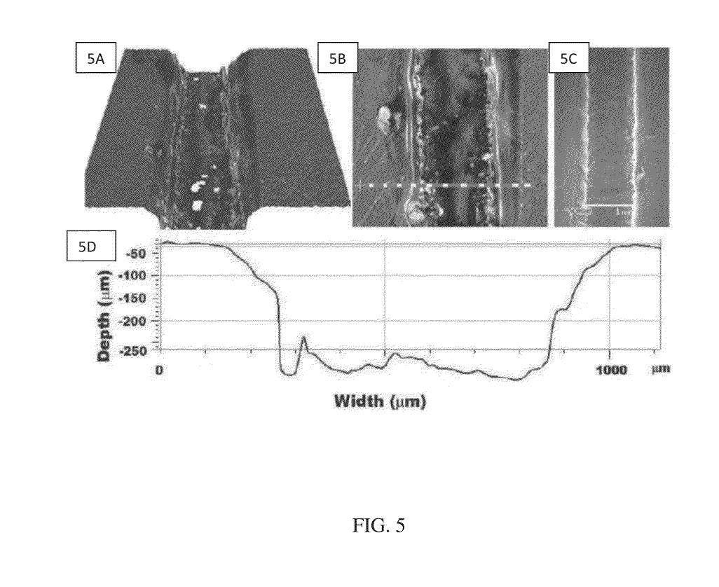

To demonstrate the reproducibility of the channels, the depth and cross section profiles were measured using contactless profilometry. FIG. 5A shows an example of a wide-angle 3D view of the microfluidic channels showing well define walls and good reproducibility. Since the contactless profilometer using light, reflection on the metal surface leads to some regions looking like holes. To show continuity and calculate depth of the channels, a line profile was measured across the channel as shown in the top down view of FIG. 5B. FIG. 5D gives the depth profile across the channel along the dotted line in FIG. 5B. Due to imaging errors the channels appear uneven and rough. The channels were imaged using scanning electron microscopy (FIG. 5C), and as expected, the channels were much smoother that obtained by surface profilometry.

### Fabrication of a T-Device

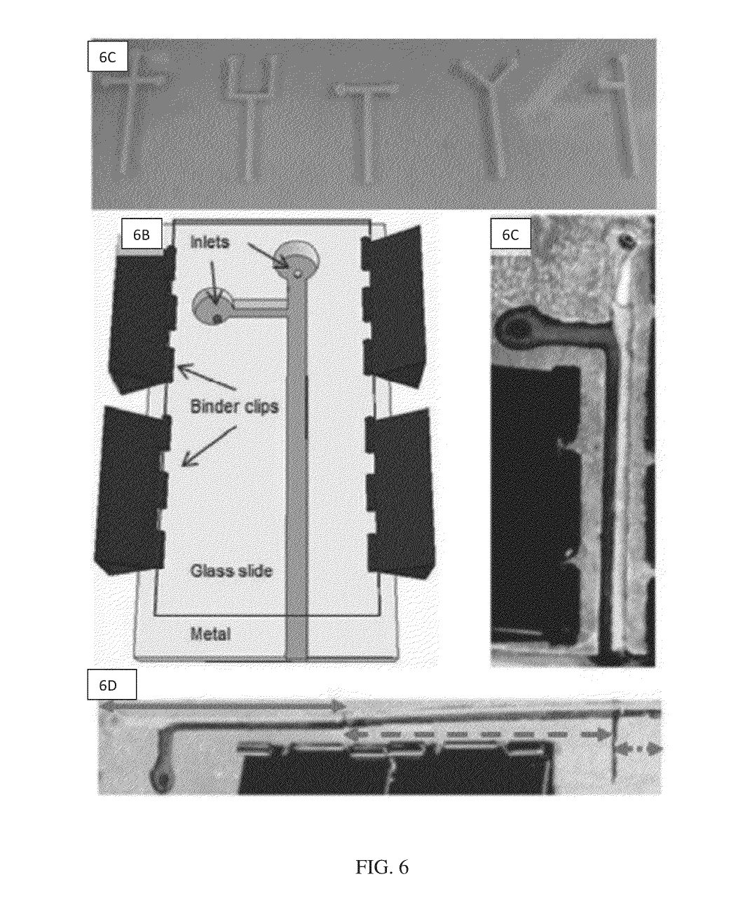

FIG. 4 is a schematic of a working T-device. Two dyed (blue and yellow) aqueous solutions were pumped into each inlet at the same rate to demonstrate that under low Reynolds numbers, as expected, laminar flow dominates. The liquids once they leave the channel and are not restricted to laminar flow. Typical devices made from PDMS have a set configuration and design that can only be changed without fabricating a new device. Metal tools and components can, however, be joined and/or repaired through welding. Similarly, metal microfluidic devices can be altered without reconfiguring or changing an already existing add-on extension. For example, a T-device was temporarily stopped and a channel length was extended by welding onto the end of the initial channel (FIG. 6C) to give an elongated device (FIG. 6D) that performed as though it was part of the original segment. This capability implies that the performance of an experiment can be improved, as needed, by inserting add-ons of different designs or extending the length of a microfluidic channel to, for example, improve mixing or separation.

### Fabrication of Droplet Generators

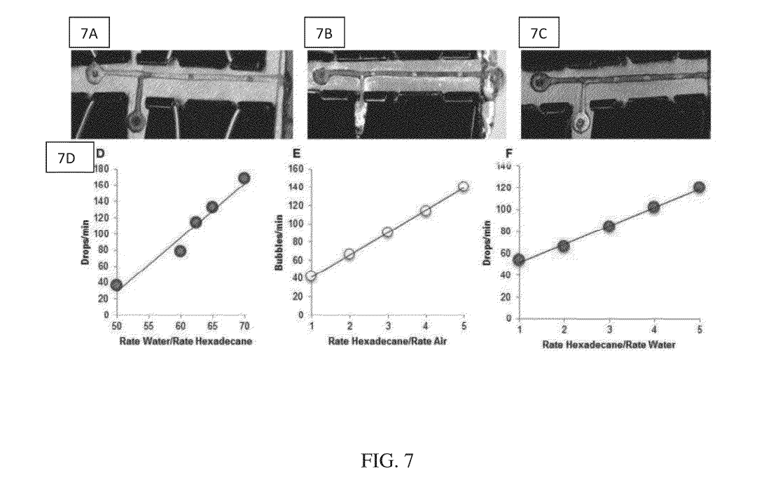

Laminar flow in microfluidic devices is one of the possible fluid applications of reconfigurable devices. Metal and metal alloys are stable to many aqueous and organic solutions while also being impermeable, and as such, can be used to fabricate droplet and bubble generators. Droplet generators were made using the commonly used T-configuration device with water and hexadecane as the orthogonal solvents to give droplets. Since metals do not wet very well with either solvent, the droplets could be either water (FIG. 7A) or hexadecane (FIG. 7C). Devices were also fabricated to make air bubbles in hexadecane (FIG. 7B) albeit with slight leakage of the carrier fluid into the air channel. The devices were operated at varying flow rates to obtain droplets of regular sizes at different frequencies. As with other microfluidic devices, our droplet and bubble generators followed a simple scaling law (Equation 1). In conventional microfluidic devices, the carrier fluid and droplet behavior are dictated by the surface chemistry of the channel. Since the surface energy of metals and metal alloy are much lower than PDMS, the metals do not swell in presence of a solvent, and droplets may be reproducibly generated from both hydrophilic and hydrophobic solvents.

$$\frac{L}{W} = 1 + α \frac{{Q}_{water}}{{Q}_{hexadecane}} \qquad ( 1 )$$

Where; L is the length and W is the width of the droplet Q_{water} and Q_{hexadecane} are the flow rates of water and hexadecane respectively, while α is a constant that depends on the geometry of the junction.

### Results

It has been demonstrated that by using a low-melting material, in this case Field's metal and related alloys, material may be molded into a device and the same metal can then be used to fabricate another device. This methodology, (termed MnM Fab), is a simple, yet powerful approach to mitigate device availability/supply in resource limited settings. This simple approach, MnM fab, significantly lowers the cost of such devices in the long run, and, is adaptable to resource-limited settings. By employing well replica molding as the fabrication technique of choice, such devices can be fabricated almost anywhere using locally available materials for molds and melting the metal on an open flame.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

What is claimed is:

1. A method of fabricating a device, comprising:
molding a material to form a first device; and
reconfiguring the first device to form a second device.

2. The method of claim 1, wherein the material comprises a low melting point material.

3. The method of claim 2, wherein the material comprises Field's metal.

4. The method of claim 1, wherein at least one of the first and second devices is a diagnostic device.

5. The method of claim 4, wherein at least one of the first and second devices is a microfluidic device, an optical grating, or a well plate.

6. The method of claim 1, wherein reconfiguring the first device involves a melt-and-mold (MnM) fabrication technique.

7. The method of claim 1, further comprising using one of the first and second devices to perform a diagnostic test.

8. The method of claim 7, further comprising reporting data collected from the diagnostic test.

9. A diagnostic kit, comprising:
a source of a reconfigurable material;
at least one mold; and
instructions for using the reconfigurable material and the at least one mold to form at least one reconfigurable device.

10. The kit of claim 9, wherein the instructions relate to a melt-and-mold (MnM) fabrication technique.

11. The kit of claim 9, wherein the reconfigurable material comprises Field's metal.

12. The kit of claim 9, wherein the at least one mold is made of plastic, rubber, metal, paper, wax, wood, stone, or glass.

13. The kit of claim 9, wherein the at least one reconfigurable device is a diagnostic device.

14. The kit of claim 13, wherein the at least one reconfigurable device is a microfluidic device, an optical grating, or a well plate.

15. The kit of claim 9, further comprising a wearable device configured to hold the components of the kit.

16. The kit of claim 9, further comprising a crucible configured to facilitate processing of the reconfigurable material.

17. The kit of claim 9, further comprising a source of heat to facilitate processing of the reconfigurable material.

18. The kit of claim 9, further comprising a diagnostic test reagent.

19. The kit of claim 9, further comprising instructions for using the at least one reconfigurable device to perform a diagnostic test.

20. The kit of claim 19, wherein the diagnostic test instructions comprise a step of communicating data collected from the diagnostic test.
